(19) United States
(12) Patent Application Publication
(10) Pub. No.: US 2026/0054201 A1
(43) Pub. Date: Feb. 26, 2026

(54) Filter Unit, Particle Collection Device with Such a Filter Unit, and Power Tool with Such a Filter Unit

(71) Applicant: Robert Bosch GmbH, Stuttgart (DE)

(72) Inventors: Daniel Barth, Leinfelden-Echterdingen (DE); Florian Esenwein, Leinfelden-Echterdingen (DE)

(21) Appl. No.: 19/304,991

(22) Filed: Aug. 20, 2025

(30) Foreign Application Priority Data
Aug. 21, 2024 (DE) 10 2024 207 936.7

(51) Int. Cl. B01D 29/13

(52) U.S. Cl. CPC B01D 29/13; B01D 2201/0415

(57) ABSTRACT

A filter unit for a particle collection device, in particular for a dust box, which is detachably attached to a power tool, in particular an eccentric or orbital sander, includes at least one filter element, in particular a pleated filter, for filtering particles from a fluid flowing through the filter element, and at least one support element arranged at one end of the filter element, in particular by a material bond. The support element has a cross-sectional shape that is congruent with a cross-sectional shape of the filter element, which deviates from a circular cross-sectional shape and is, in particular, star-shaped.

This application claims priority under 35 U.S.C. § 119 to patent application no. DE 10 2024 207 936.7, filed on Aug. 21, 2024 in Germany, the disclosure of which is incorporated herein by reference in its entirety.

### BACKGROUND

A filter unit for a particle collection device that can be detachably attached to a hand-held power tool has already been proposed, comprising at least one filter element for filtering particles from a fluid flowing through the filter element and at least one support element arranged at one end of the filter element.

### SUMMARY

The disclosure relates to a filter unit for a particle collection device, in particular for a dust box, which can be detachably fastened to a power tool, in particular an eccentric or orbital sander, with at least one filter element, in particular a pleated filter, for filtering particles from a fluid flowing through the filter element, and with at least one support element which is arranged at one end of the filter element, in particular by means of a material bond.

The disclosure proposes that the support element has a cross-sectional shape that is congruent with a cross-sectional shape of the filter element, which deviates from a circular cross-sectional shape and is, in particular, star-shaped.

The embodiment of the filter unit according to the disclosure has the advantage that a filter gap, in particular on a particle-filtered exhaust air side, of the filter element can be limited. A filter pleat gap recess of the filter element can be reinforced, in particular against deformation, which is particularly advantageous. Due to the congruent cross-sectional shape of the support element and the filter element, particularly in a pleated filter, the filter pleat spaces on the inflow side between adjacent, outwardly facing pleats of the filter element at an axial end of the filter element, at which the support element is arranged, are advantageously open in order to enable the filter element to be brushed out along a, in particular, entire longitudinal axis of the filter element by means of, for example, a brush, a paintbrush or the like. Particularly advantageous when the filter unit is held upright, particles or dust can fall out of the filter pleat spaces due to gravity, especially when blows are applied to the filter, in particular to individual filter pleats, by means of a filter cleaning unit. When the filter unit is held upright, particles or dust can preferably fall out of the filter unit due to gravity without collecting on the support element. Furthermore, the spaces between the filter folds can be advantageously flowed through with particle-laden air. It can be advantageous to provide particularly efficient filtering of a fluid from particles.

The filter unit is designed in particular to separate particles, impurities and/or substances which are removed from a workpiece by a machining tool arranged on a tool holder of the power tool from a fluid flow, in particular an air flow. The particles may be, in particular, dust, abrasion, chips or the like, which are produced by machining a material, for example wood, metal, plastic or the like, with the power tool, in particular with a machining tool arranged on a tool holder of the tool holder, such as an abrasive, a cutting disc, a grinding wheel, a grinding belt, a sawing tool, a milling tool or the like. The filter unit is preferably arranged on, preferably in, a collection container of the particle collection device. The filter unit is particularly preferred when it can be cleaned of particles or dust deposited in the spaces between the filter pleats by means of a filter cleaning unit, for example by means of a fluid guide element which may have impulse elements for striking the pleats of the filter element. “Provided” is understood in particular as meaning specifically adapted, specifically programmed, specifically designed and/or specifically equipped. The fact that an object is intended for a specific function should be understood in particular to mean that the object fulfills and/or executes this specific function in at least one application and/or operating mode.

The filter element is preferably designed as a pleated filter, in particular as a lamella filter, which is, for example, hollow cylindrical, cylindrical, cuboid or similar. Preferably, the outer edges of the pleats of the pleated filter are arranged in a circular pattern with respect to the plane perpendicular to the longitudinal axis of the filter unit. Preferably, the outer edges of the folds of the filter element are arranged perpendicular to the longitudinal axis of the filter unit on a first imaginary circle, wherein the inner edges of the folds of the filter element are arranged perpendicular to the longitudinal axis of the filter unit on a second imaginary circle. A filter medium of the filter element can, for example, be made of textiles, paper, fleece, glass fiber, a metal mesh, synthetic membranes, a combination of these, or another material that appears suitable to a person skilled in the art. The longitudinal axis of the filter element preferably runs parallel to a main extension plane of the filter unit. Preferably, the longitudinal axis of the filter element is parallel to a main direction of extension of the filter unit, in particular through a geometrical center point of the filter unit. The “main extension plane” of an element or a component shall be understood in particular to mean a plane which is parallel to the largest lateral surface of the smallest imaginary cuboid which just completely encloses the element or component and which passes in particular through the center of the cuboid. A “main direction of extension” of an object is understood to be a direction that runs parallel to the longest edge of a smallest geometric cuboid that just completely encloses the object. Preferably, particle-laden air is directed toward an outer side of the filter element, and particle-filtered air can flow out through an inner channel running parallel to the longitudinal axis of the filter unit and bounded by the lamella filter.

The support element is preferably designed to give the filter element dimensional stability. The support element is preferably arranged at an axial end of the filter element. In particular, the support element closes off the inner channel of the filter element at the axial end in terms of flow. It is also possible for the support element to have a recess through which the fluid, in particular particle-cleaned air, can flow out of or into the inner channel of the filter element. It would also be conceivable for the filter unit to have at least one further support element. The additional support element may be arranged at the axial end of the filter element facing away from the support element. Alternatively, it is conceivable that the additional support element is arranged between, for example centrally between, the axial ends of the filter element. It is particularly preferred that the support element is arranged by means of a material bond, for example by means of an adhesive bond, at an axial end of the filter element. It is also possible for the support element to be injection molded directly onto the axial end of the filter element. The support element is preferably made of a plastic. It is also possible for the support element to be made of a metal, rubber, or a combination of materials.

Furthermore, it is proposed that the support element has at least two, preferably more than two, radial extensions, in particular star prongs, which are mutually spaced along a circumferential direction with respect to their, in particular radial, ends, in particular arranged symmetrically about a center axis of the support element, preferably in order to define the cross-sectional shape of the filter element which deviates from a circular cross-sectional shape. Preferably, the radial extensions, in particular star prongs, are arranged along a circumferential direction at least with respect to their radially outer ends mutually spaced. It is conceivable that the filter unit is designed in an alternative embodiment, which is independent of the support element having a cross-sectional shape congruent with a cross-sectional shape of the filter element, to provide a solution to the problem according to the disclosure. Preferably, the filter unit in the alternative embodiment, in particular in the embodiment designed independently of the support element with a cross-sectional shape congruent with a cross-sectional shape of the filter element, comprises at least the filter element, in particular the pleated filter, for filtering particles from the fluid flowing through the filter element, and at least the support element, which is arranged at the end of the filter element, in particular by means of a material bond, wherein the support element has at least two, preferably more than two, radial extensions, in particular star prongs, which are mutually spaced along a circumferential direction with respect to their, in particular radial, ends, in particular are arranged symmetrically around a center axis of the support element, preferably to define the cross-sectional shape of the filter element, which deviates from a circular cross-sectional shape. Preferably, the radial extension has a main direction of extension in the radial direction relative to the filter unit and perpendicular to the longitudinal axis of the filter unit. The support element preferably has a number of radial extensions that corresponds to the number of pleats of a filter element. Particularly preferred are radial extensions along the circumferential direction, which preferably extend in a plane perpendicular to the longitudinal axis of the filter unit and are arranged at equal angles to each other. The spacing between the ends of the radial extensions preferably defines the filter pleat spaces between the radial extensions, in particular between the pleats of the pleated filter, which are to be cleaned by means of a filter cleaning unit, for example by being brushed out with a brush, a paintbrush or the like. It would also be conceivable for the support element to have a number of radial extensions that is different from the number of pleats on the filter element. The support element is preferably designed as a single piece, in particular as one piece. The term “as a single piece” is to be understood in particular, at least materially bonded, for example bonded by a welding process, an adhesive bonding process, an injection molding process, and/or another process that appears reasonable to a person skilled in the art, and/or advantageously formed in one piece, such as by manufacturing from a casting and/or by manufacturing in a single-component or multi-component injection molding process and advantageously from a single blank. Advantageously, “as a single piece” should also be understood as “integrally”. The term “integrally” should be understood in particular to mean to be formed as a single piece. Preferably, this single piece is manufactured from a single blank, a mass and/or a casting, particularly preferably in an injection molding method, especially a single and/or multi-component injection molding method. However, it is also conceivable that the radial extensions are formed separately from the support element and are connected to the support element in an interlocking, force-fit and/or materially bonded manner. Preferably, the radial extensions are made of a plastic. Alternatively, the radial extensions can be made of a metal, a rubber or a combination of materials. Advantageously, a particularly high degree of dimensional stability can be provided for the filter unit. Particularly advantageous is that particles can be brushed out of the filter element along the pleats of the filter element over the entire longitudinal axis of the filter unit via the axial end, for example with a brush. A particularly high efficiency of filtering the fluid from particles can be achieved. In addition, a particularly long service life of the filter unit is advantageous.

It is also proposed that the support element has at least two radial extensions, in particular the at least two radial extensions, each of which has a abutment surface for bearing against the filter element along a circumferential direction of the filter element, wherein the abutment surfaces preferably delimit a receptacle for an arrangement of filter star prongs of the filter element designed as a pleated filter. Preferably, the radial extensions are designed as a receiving area for receiving and/or gripping the ends of the filter element. Alternatively, it is conceivable that the abutment surfaces and the filter element are connected to each other by means of a material bond, for example by means of an adhesive bond. The filter element can be arranged with the tips of the folds and the lateral surfaces of the folds lying against the abutment surfaces from the inside, in particular by means of a material bond with the abutment surfaces. However, it would also be conceivable for the filter element to be applied to the outer sides of the abutment surfaces, in particular by means of a material bond. It is advantageous to provide a large adhesive surface for bonding the support element to the filter element. This results in a favorably high stability of the filter element. A particularly advantageous feature is the long service life of the filter unit.

Furthermore, it is proposed that the support element has at least one, in particular extending at least substantially parallel to a center axis of the filter element, preferably cylindrical, inner support wall for supporting the filter element, which is arranged closer to the center axis with respect to a center axis of the filter element than two radial extensions, in particular the at least two radial extensions, of the support element. The inner support wall is preferably provided to support the edges of the filter element facing the center axis of the filter element. Preferably, the inner support wall is provided to support an axial end region of inner edges of folds of the filter element. Preferably, the inner support wall is formed by an annular wall element, which in particular extends symmetrically around the longitudinal axis of the filter unit. Preferably, the inner support wall is surrounded by the radial extensions. Preferably, the inner support wall has a maximum outer diameter that corresponds to the diameter of a circle lying in a plane perpendicular to the longitudinal axis of the filter element, on which the inner edges of the filter element lie. Preferably, a maximum extension of the inner support wall extending at least substantially parallel to a center axis of the filter element, in particular parallel to the longitudinal axis of the filter unit, is more than 5%, particularly preferably more than 10%, particularly preferably more than 15% of a maximum axial length of the filter element extending parallel to the longitudinal axis. A radial wall thickness of the inner wall is preferably a maximum of 10%, preferably a maximum of 5%, particularly preferably a maximum of 2.5% of the diameter of the cylindrical inner support wall. Alternatively, it is also conceivable that the inner support wall is designed as a solid cylinder. It is possible for the inner support wall to be designed as a separate component. The inner support wall is preferably made of plastic. Alternatively, it is conceivable that the inner support wall could be made of metal, rubber or a combination of materials. Such an embodiment can provide an advantageous guide for the filter element during assembly. Furthermore, this results in an advantageously large support and/or adhesive surface for the edges of the filter element pointing towards the center axis. In addition, deformation of the filter element can be counteracted when the filter cleaning unit is actuated.

It is further proposed that the support element has at least two radial extensions, in particular the at least two radial extensions, and at least one, in particular sword-like, mounting centering extension, wherein the mounting centering extension is arranged on at least one of the radial extensions on a side of the support element, in particular the radial extension, facing away from the filter element. It is conceivable that the filter unit is designed in an alternative embodiment, which is independent of the support element having a cross-sectional shape congruent with a cross-sectional shape of the filter element, to provide a solution to the problem according to the disclosure. Preferably, the filter unit in the alternative embodiment, in particular in the embodiment designed independently of the support element with a cross-sectional shape congruent with a cross-sectional shape of the filter element, comprises at least the filter element, in particular the pleated filter, for filtering particles from the fluid flowing through the filter element, and at least the support element, which is arranged at the end of the filter element, in particular by means of a material bond, wherein the support element has at least two radial extensions, in particular the at least two radial extensions, and at least one, in particular a sword-like, mounting centering extension, wherein the mounting centering extension is arranged on at least one of the radial extensions on a side of the support element, in particular of the radial extension, facing away from the filter element. The mounting centering extension is preferably intended to enable the filter unit to be centered in the collection container of the particle collection device, whereby the mounting centering extension is preferably supported against an inner wall of the particle collection device. Preferably, the radial extension of the mounting centering extension decreases from preferably the middle of the axial extension of the mounting centering extension starting from the support element in the axial direction facing away from the support element, for example linearly. Alternatively, the radial extension of the mounting centering extension can also decrease in an arc shape or similar. The support element preferably has three mounting centering extensions, which are arranged, for example, offset at equal angles in a plane perpendicular to the longitudinal axis of the filter unit. It is particularly preferred that every second radial extension has a mounting centering extension. However, it is also conceivable that the support element has a different number of mounting centering extensions. Preferably, the mounting centering extension is formed in one piece with the support element. Alternatively, it is also conceivable that the mounting centering extension is designed separately from the support element and is connected to the support element, in particular with a material bond. Preferably, the mounting centering extension is made of plastic. However, it is also conceivable that the mounting centering extension is made of metal, rubber or a combination of materials. Advantageously, a centering aid is provided for mounting the filter element in the particle collection device. Furthermore, the mounting centering extensions advantageously limit the freedom of movement of the filter unit. A particularly low-vibration device can be provided when the power tool is in operation. Furthermore, a particularly low-noise device is advantageously provided.

It is further proposed that the support element has at least one serrated flow optimization geometry, which is arranged on a side of the support element facing away from the filter element and is arranged adjacent to at least two radial extensions, in particular to the at least two radial extensions, of the support element. It is conceivable that the filter unit is designed in an alternative embodiment, which is independent of the support element having a cross-sectional shape congruent with a cross-sectional shape of the filter element, to provide a solution to the problem according to the disclosure. Preferably, in the alternative embodiment, in particular in the embodiment formed independently of the support element with a cross-sectional shape congruent with a cross-sectional shape of the filter element, the filter unit comprises at least the filter element, in particular the pleated filter, for filtering particles from the fluid flowing through the filter element and at least the support element which is arranged at the end of the filter element, in particular in a materially bonded manner, wherein the support element has at least one serrated flow optimization geometry which is arranged on a side of the support element facing away from the filter element and is arranged adjacent to at least two radial extensions, in particular to the at least two radial extensions, of the support element. The serrated flow optimization geometry is preferably intended to guide the particle-laden fluid between the radial extensions to the filter element, in particular into the pleats of the pleated filter. Preferably, a center axis of the serrated flow optimization geometry is arranged coaxially with the center axis of the support element. The serrated flow optimization geometry is particularly preferably arranged between the radial extensions. The serrated flow optimization geometry is preferably in the shape of a spherical cap. An embodiment in the form of a paraboloid or a pointed cone would also be conceivable. It is particularly preferable for the serrated flow optimization geometry to be hollow spherical in the direction axially away from the support element. Preferably, the serrated flow optimization geometry is formed in one piece with the support element. However, it would also be conceivable for the serrated flow optimization geometry to be designed separately and connected to the support element, in particular with a material bond. This results in advantageous fluid dynamics of the fluid flowing through an inlet opening of the particle collection device to the filter element. Furthermore, the flow noise of a particle-filtered fluid flow on the side facing the filter unit can be kept to a minimum.

Furthermore, it is proposed that the filter unit has a further support element which delimits at least one outlet opening for discharging a fluid, in particular a particle-filtered fluid, from the filter element and is arranged at an end of the filter element facing away from the support element, in particular is connected to the filter element by a material bond. It is conceivable that the filter unit is designed in an alternative embodiment, which is independent of the support element having a cross-sectional shape congruent with a cross-sectional shape of the filter element, to provide a solution to the problem according to the disclosure. Preferably, in the alternative embodiment, in particular in the embodiment formed independently of the support element with a cross-sectional shape congruent with a cross-sectional shape of the filter element, the filter unit comprises at least the filter element, in particular the pleated filter, for filtering particles from the fluid flowing through the filter element, and at least the support element, which is arranged at the end of the filter element, in particular in a materially bonded manner, wherein the filter unit has a further supporting element which delimits at least one outlet opening for discharging a fluid, in particular a particle-filtered fluid, from the filter element and is arranged at an end of the filter element remote from the supporting element, in particular is connected to the filter element in a materially bonded manner. The further support element is preferably designed as a closure element, particularly preferably as a closure cap for a collection container, in particular a collection container, of the particle collection device. Preferably, the additional support element has a screw thread for screwing onto the collection container of the particle collection device. The outlet opening is preferably intended to allow the particle-filtered fluid to flow out of the filter unit. Preferably, the further support element has a further inner support wall on which the filter element, in particular the radially inward-facing edges of the filter element, is/are arranged, in particular by means of a material bond. The additional support element is preferably made of plastic. However, it is also conceivable that the additional support element is made of metal, rubber or a combination of materials. A particularly high level of stability can be advantageously provided for the filter element. Furthermore, the filter unit offers particularly advantageous sustainability and advantageous compatibility for a large number of particle collection devices, which can be advantageously retrofitted with such a filter unit.

The disclosure also relates to a particle collection device, in particular a dust box, for a power tool, in particular an eccentric or orbital sander, with the filter unit according to the disclosure. Preferably, the particle collection device has at least one collection container, in particular a collection container, and at least one filter cleaning element for cleaning the filter unit of particles or dust deposited in the filter element. Preferably, the particle collection device can be detachably attached to the power tool, in particular to a suction nozzle of the power tool. Preferably, the particle collection device comprises a connection interface which is provided for a positive and/or non-positive connection with the power tool, in particular with the suction nozzle. Preferably, the particle collection device has an essentially cylindrical shape. Preferably, the filter cleaning unit is designed as a fluid guide element for discharging the particle-filtered fluid with at least one impulse element for transmitting a pulse to the filter unit. In a particularly preferred state, the filter cleaning unit is completely surrounded by the filter unit. Cleaning the filter unit can be made advantageously easy. In addition, particularly efficient filtering of the particle-laden fluid can be achieved. Furthermore, a particularly long service life of the filter unit can be advantageously provided.

It is further proposed that in the particle collection device, the support element has a guide and/or bearing element, in particular a hollow plain cylindrical element, on a side of the support element facing the filter element for guiding and/or bearing a filter cleaning unit. The filter cleaning unit is preferably designed to clean the filter element of particles and/or dust. Preferably, the filter cleaning unit has at least one impulse element, by means of which impacts can be exerted against the filter unit, in particular against the pleats of the filter element. The filter cleaning unit also preferably has a wooden cylindrical fluid guide element, which can be pushed into the guide and/or bearing element during assembly. The fluid guiding element is preferably arranged rotatably in the guide and/or bearing element. Alternatively, a different embodiment of the guide and/or bearing element is also conceivable, which the person skilled in the art would consider useful. Preferably, the guide and/or bearing element is formed in one piece with the support element. Advantageously, the filter cleaning unit can be easily installed. Furthermore, the filter cleaning unit is advantageously stabilized.

Furthermore, it is proposed that the particle collection device has a collection unit which comprises a collection container, in particular a collecting vessel, and a filter cleaning unit which comprises a fluid guide element, the filter unit having a further supporting element which delimits at least one outlet opening for discharging a fluid, in particular a particle-filtered fluid, from the filter element and is arranged at an end of the filter element facing away from the supporting element, in particular is connected to the filter element by means of a material bond, wherein the outlet opening has a cross-sectional shape, in particular deviating from a circular cross-section and preferably having at least one extension, which is intended to enable the fluid guiding element to be introduced into the collection container together with an impulse element of the filter cleaning unit extending over an outer surface of the fluid guiding element, wherein the filter element is arranged in such a way that the at least one extension is arranged within a fluid flow channel delimited by the filter element. Preferably, the at least one extension is arranged in relation to the filter element between two radially inward-pointing pleat edges of the filter element, in particular of the pleated filter, which are adjacent in a circumferential direction of the filter element that is perpendicular to the longitudinal axis of the filter element. Preferably, the outlet opening of the further support element may have more than one extension, the extensions preferably being provided to allow the fluid guiding element to be introduced into the collection container together with one or more impulse element(s) of the filter cleaning unit extending over an outer surface of the fluid guiding element. It is advantageous to be able to insert the filter cleaning unit into the filter unit without bending the impulse element. Furthermore, damage to the filter element when inserting the filter cleaning unit can be counteracted.

In addition, the disclosure is based on a power tool, preferably a hand-held power tool, in particular an eccentric or orbital sander, with at least one filter unit according to the disclosure or with at least one particle collection device according to the disclosure. The power tool is preferably designed as a hand-held power tool. The power tool is preferably designed as a hand-held orbital or eccentric sander. It is also conceivable that the power tool has a different embodiment which appears sensible to a person skilled in the art, such as a drill, a drill and/or hammer machine, a sawing machine, a planing machine, a milling machine, an angle grinder, a garden tool, a multifunctional power tool, or the like. In particular, the power tool has a blower for removing particles. Preferably, the material removed from a workpiece machined by the power tool can be removed by an air flow generated, for example, by a fan impeller, in particular a fan impeller for cooling a motor of the power tool. Alternatively, the power tool may have a pump or suction unit driven by the motor of the power tool to remove the material removal. A blower, pump, or similar device driven by a separate motor would also be conceivable.

The filter unit, particle collection device and/or power tool according to the disclosure should not be limited to the application and embodiment described above. In particular, the filter unit, the particle collection device, and the power tool according to the disclosure may have a number of individual elements, components, and units that differs from the number specified herein in order to perform the function described herein. Additionally, regarding the ranges of values indicated in this disclosure, values lying within the limits specified hereinabove are also provided to be considered as disclosed and usable as desired.

### BRIEF DESCRIPTION OF THE DRAWINGS

Further advantages follow from the description of the drawings below. An exemplary embodiment of the disclosure is shown in the drawing. The drawing, the description, and the claims contain numerous features in combination. A person skilled in the art will appropriately also consider the features individually and combine them into additional advantageous combinations.

The figures show:

FIG. 1 a schematic illustration of a power tool with a particle collection device,

FIG. 2 the particle collection device in a schematic sectional view with a sectional plane parallel to a longitudinal axis of a filter unit according to the disclosure,

FIG. 3 a collection container, a closure element and a filter cleaning unit of the particle collection device in a schematic exploded view,

FIG. 4 the filter cleaning unit with impulse elements, inlet openings, latching elements and an actuating element for the particle collection device in a schematic illustration,

FIG. 5 a fluid guiding element of the filter cleaning unit in a schematic sectional view with a sectional plane perpendicular to a longitudinal axis of the fluid guiding element,

FIG. 6 the closure element of the particle collection device, with an outlet opening,

FIG. 7 the filter unit according to the disclosure for the particle collection device in a schematic illustration,

FIG. 8 a support element of the filter unit according to the disclosure for a particle collection device, and

FIG. 9 a cross-sectional plane of a support element for the filter unit according to the disclosure of a particle collection device, lying parallel to a longitudinal axis of the filter unit according to the disclosure.

### DETAILED DESCRIPTION

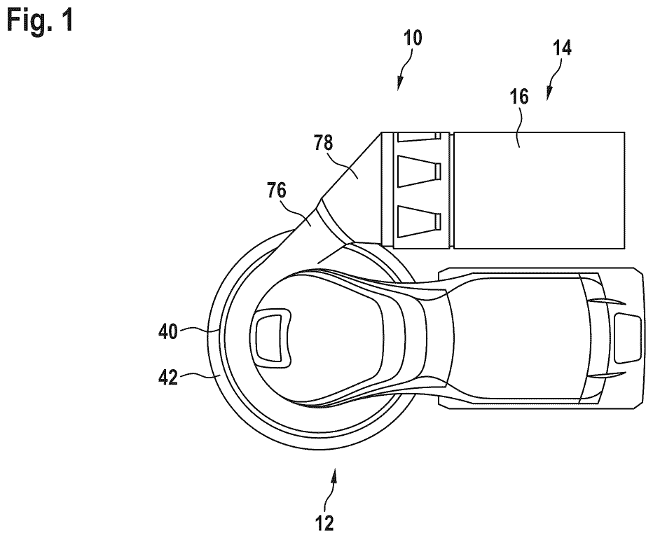

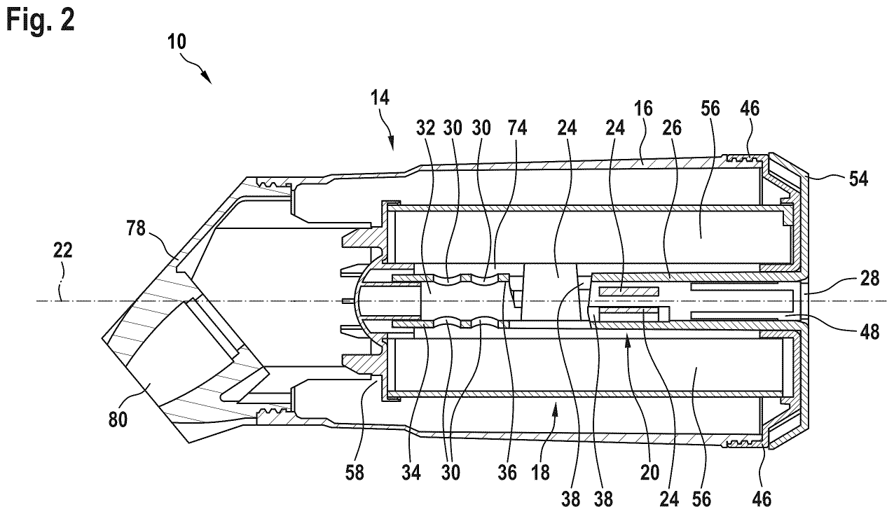

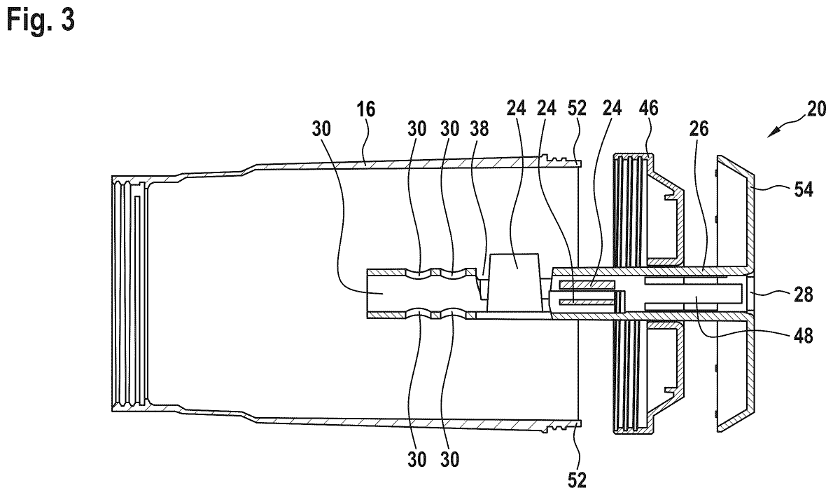

FIG. 1 shows a power tool 12 with a particle collection device 10. The power tool 12 is configured as a hand-held power tool. The power tool 12 is designed as an electric eccentric sander, in particular as a battery-powered eccentric sander. Alternatively, the power tool 12 could be designed as a fuel-powered eccentric or orbital sander, as a compressed air-powered eccentric or orbital sander, as a cut-off grinder, as a belt sander, as a drill, as a hand-held circular saw or the like.

The power tool 12 has a tool holder 40. A machining tool 42, in particular a grinding wheel, is arranged on the tool holder 40. The tool holder 40 is formed by a support plate. The tool holder 40 is formed, for example, by a circular support plate with a hook-and-loop surface. The machining tool 42 arranged on the tool holder 40 of the power tool 12 is intended to remove particles, in particular dust, from a workpiece during operation. Alternatively, however, it is also conceivable, in particular depending on the embodiment of the power tool 12, that the machining tool is designed as a cutting disc, a grinding belt, a milling tool, a saw blade or the like.

The power tool 12 comprises a suction nozzle 76. The suction nozzle is arranged on a housing of the power tool 12. The particle collection device 10 is provided for detachable connection to the suction nozzle 76.

The particle collection device 10 comprises a collection unit 14 for collecting the particles removed by the machining tool 42. The collection unit 14 comprises a collection container 16. The collection container 16 is configured as a collection container. The collection container is essentially cylindrical in shape. However, a polygonal shape of the collection container is also conceivable. The collection container is formed from a plastic, in particular a transparent plastic.

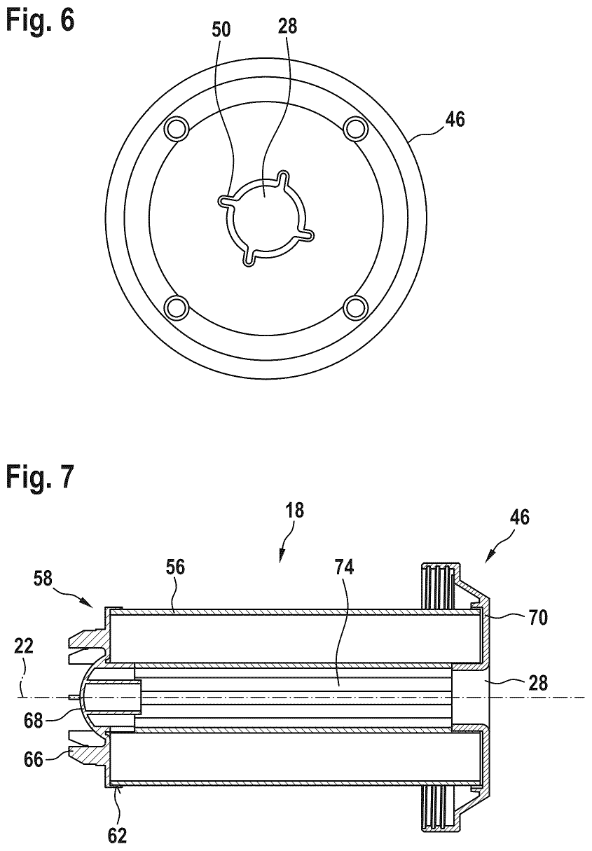

The particle collection device 10 comprises the collection unit 14 for collecting particles. The collection container 16 is configured as a dimensionally stable collection container. The shape of the collection container is substantially cylindrical. The collection container 16 is made of a plastic. The collection container 16 is open at both end sides. The collection container 16 is at least essentially formed by a cylindrical casing, in particular a hollow cylindrical casing. The collection unit 14 has a closure element 46 in the form of a closure cap. The closure element 46 is intended to close an opening of the collection container 16. The closure element 46 limits an outlet opening 28. The outlet opening 28 is arranged in the center of the closure element 46. Alternatively, however, it is also conceivable that the outlet opening 28 is arranged laterally offset to a center axis of the closure element 46 running parallel to a longitudinal axis 22. The outlet opening 28 has a shape deviating from a circular cross-section with at least one extension 50 delimiting a slit-like indentation of the outlet opening 28. In the present embodiment, the shape of the outlet opening has four such extensions 50. This embodiment of the shape of the outlet opening 28 with the extensions 50 makes it possible to insert the fluid guiding element 26 together with the impulse elements 24 extending over an outer surface 44 of the fluid guiding element 26 into the collection container 16, in particular without bending the impulse elements 24 (FIG. 6).

In the embodiment as a closure cap, the closure element 46 has a screw thread for screwing onto the collection container 16 of the collection unit 14. The closure element 46 is connected to the collection container 16 by means of a screw connection. Alternatively, however, it is also conceivable that the closure element is arranged on the collection container 16 by means of a plug connection, for example by means of a bayonet connection.

The particle collection device 10 further comprises a filter unit 18 for filtering particles from a fluid flow passing through the collection container 16. The filter unit 18 comprises a filter element 56 designed as a pleated filter, in particular as a lamella filter. The filter unit 18 has a hollow cylindrical geometry. However, it is also conceivable that the filter unit 18 has a cylindrical shape, a cuboid shape or the like. The filter element 18 has a circular cross-sectional shape when viewed in a plane extending perpendicular to the longitudinal axis 22. The outer edges of the folds of the pleated filter are arranged in a circular pattern with respect to the plane perpendicular to the longitudinal axis 22 of the filter unit 18. A filter medium of the filter unit 18 is formed from filter paper. Alternatively, however, the filter medium of the filter unit 18 may be formed from a nonwoven fabric, a synthetic material, textiles, glass fiber, a metal mesh, a combination of materials, or the like. The outside of the filter element 56 is exposed to particle-laden air, and particle-filtered air can flow out through a fluid flow channel 74 bounded by the filter element 56 parallel to the longitudinal axis 22 of the filter unit 18. The particle-filtered fluid flows out of the particle collection device 10 through the outlet opening 28.

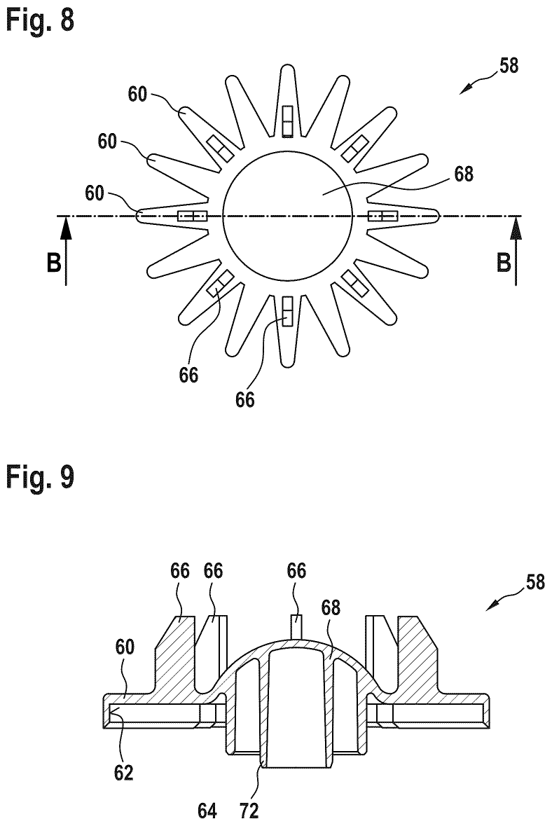

The filter unit 18 comprises a support element 58. The support element 58 is arranged by means of a material bond at an axial end of the filter element 56. The filter unit 18 comprises the support element 58. The support element 58 is arranged at an axial end of the filter element 56, in particular by means of a material bond. The support element 58 has a cross-sectional shape that is congruent with a cross-sectional shape of the filter element 56, which deviates from a circular cross-sectional shape. In the present embodiment of the filter unit 18 with a filter element 56 designed as a pleated filter, the support element 58 is star-shaped. As shown in detail in FIGS. 8 and 9, the support element 58 comprises at least two radial extensions 60, in the present case a plurality of radial extensions 60 designed as star prongs. For the sake of clarity, only some of the radial extensions 60 are provided with a reference numeral. The radial extensions 60 are spaced apart from each other along a circumferential direction with respect to their radial ends. In the present embodiment, the radial extensions 60 are arranged symmetrically about a center axis of the support element 58 extending coaxially with the longitudinal axis 22. Alternatively, however, it is also conceivable that the radial extensions 60 are not arranged symmetrically about a center axis of the support element 58 extending coaxially with the longitudinal axis 22. The radial extensions 60 define the cross-sectional shape of the filter element 56, which deviates from a circular cross-sectional shape. The radial extensions 60 each have a abutment surface 62 for bearing against the filter element 56 along a circumferential direction of the filter element 56. In the present embodiment, the abutment surfaces 62 limit the reception of an arrangement of filter star prongs of the filter element 56, which is designed as a pleated filter. The abutment surfaces 62 support the filter element 56 axially, radially, and circumferentially. This results in a positive locking between the abutment surfaces 62 and the axial end of the filter element 56 designed as a pleated filter in the radial direction of the filter element 56 and in the circumferential direction of the filter element 56. Alternatively, it is also conceivable that the abutment surfaces 62 of the support element 58 are completely surrounded by the filter element 56. In the present embodiment, the support element 58 is connected to the axial end of the filter element 58 by means of an adhesive bond. The support element 58 further comprises a cylindrical inner support wall 64 extending parallel to a center axis of the filter element 56. FIG. 9 shows the inner support wall 64 in a cross section through the support element 58 in FIG. 8, indicated by the dashed line and viewed in direction “B”. With respect to the center axis of the filter element 56, the inner support wall 64 is arranged closer to the center axis than the radial extensions 60 of the support element 58. The inner support wall 64 supports an axial end region of inner edges of folds of the filter element 56 designed as a pleated filter. In the present embodiment, the inner support wall 64 is formed by an annular wall element which extends symmetrically about the longitudinal axis 22 of the filter unit 18. The support element 58 further has at least one sword-like mounting centering extension 66. The mounting centering extension 66 is arranged on at least one of the radial extensions 60 on a side of the support element 58, in particular of the radial extension 60, facing away from the filter element 56. In the present embodiment, every second radial extension 60 has such a mounting centering extension 66. However, it is also conceivable that only every third or every fourth extension 60 or the like has such a mounting centering extension 66. A radial extension of the mounting centering extension 66 from the center of the axial extension of the mounting centering extension 66 starting from the support element 58 decreases linearly in the axial direction away from the support element 58 by 50% of the maximum radial extension of the mounting centering extension 66. Alternatively, the mounting centering extension 66 may have a different shape suitable for centering the filter unit 18 in the collection container 16 of the collection unit 14. The support element 58 further comprises a serrated flow optimization geometry 68. The serrated flow optimization geometry 68 is arranged on a side of the support element 58 facing away from the filter element 56. The serrated flow optimization geometry 68 is also arranged adjacent to the at least two radial extensions 60 of the support element 58. A center axis of the serrated flow optimization geometry 68 is arranged coaxially with the center axis of the support element 58. The serrated flow optimization geometry 68 is designed in the present case as a hollow spherical cap in the direction axially away from the support element 58. Alternatively, a differently designed geometry for the serrated flow optimization geometry 68 is conceivable. The support element 58 has a hollow plain cylindrical guide and/or bearing element 72 on a side of the support element 58 facing the filter element 56 for guiding and/or bearing the filter cleaning unit 20. The filter cleaning unit 20 can be inserted into the guide and/or bearing element 72 and is rotatably mounted in the guide and/or bearing element 72.

The particle collection device 10 further comprises a filter cleaning unit 20 for cleaning the filter element 56 of the filter unit 18. The filter cleaning unit 20 is arranged in the collection container 16. The filter cleaning unit 20 is rotatable about the longitudinal axis 22 relative to the collection container 16 and to the filter unit 18. However, it is also conceivable that the filter cleaning unit 20 is mounted so as to be rotatable about the longitudinal axis 22 relative to the collection container 16 or rotatable relative to the filter unit 18. The filter cleaning unit 20 has four impulse elements 24 which, when the filter cleaning unit 20 rotates, each transmit a pulse to individual folds of the filter element 56 of the filter unit 18. The filter cleaning unit 20 has a fluid guiding element 26 designed as a hollow shaft. The fluid guiding element 26 extends over the entire longitudinal extent of the filter unit 18. The fluid guiding element 26 discharges particle-filtered air on the clean air side of the filter unit 18 through the outlet opening 28 from the collection container 16.

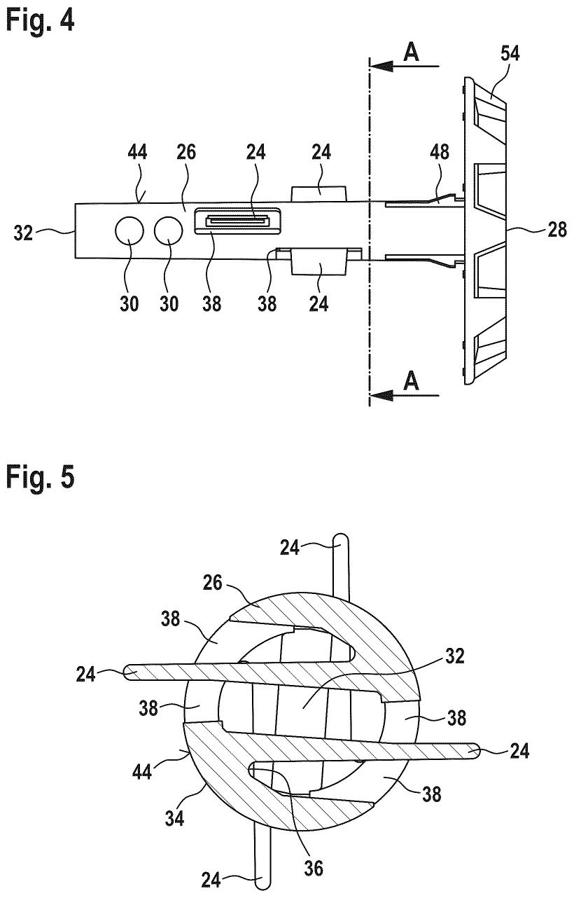

An actuating element 54 is arranged on the filter cleaning unit 20 to rotate the impulse element 24 together with the fluid guiding element 26 about the longitudinal axis 22 of the filter cleaning unit 20. The actuating element 54 is designed as a hand wheel. Alternatively, it is also possible for the actuating element 54 to be actuated by means of a servomotor. The collection container 16 has two securing units 52 to prevent the collection container 16 and the closure element 46 of the collection unit 14 from becoming detached, in particular accidentally, when the actuating element 54 is actuated. The securing units 52 are designed as axially elastic snap-in knobs which lock into a complementary locking geometry arranged on the closure element 46. The two snap-in knobs are arranged diametrically opposite each other on the collection container 16. However, it is also conceivable that the collection container has several snap-in knobs in a different arrangement. The snap-in knobs 52 designed as locking studs face the closure element 46 in the axial direction. However, it is conceivable that the securing units 52 are arranged on the outside of the collection container 16. The fluid guiding element 26 of the filter cleaning unit 20 has an inlet opening 30, in particular four inlet openings 30 (see also FIG. 4). The fluid flows through the inlet openings 30 into an inner channel 32 of the fluid guiding element 26. The inlet openings 30 are arranged in an outer wall 34 of the fluid guiding element 26, which runs at least substantially parallel to the longitudinal axis 22 of the filter cleaning unit 20. The inlet openings 30 for the fluid into the inner channel 32 of the fluid guiding element 26 are arranged in a region facing away from the outlet opening 28 in the outer wall 34 of the fluid guiding element 26, which runs essentially parallel to the longitudinal axis 22 of the filter cleaning unit 20. The region facing away extends from the end of the fluid guiding element 26 facing away from the outlet opening 28 over 20% of a maximum axial length of the fluid guiding element 26 extending parallel to the longitudinal axis 22. The inlet openings 30 are of the same design and are circular in shape. The diameter of the circular inlet openings 30 is at most 20% of an outer circumferential length of the fluid guiding element 26 perpendicular to the longitudinal axis 22. Two inlet openings 30 are arranged axially offset from one another in the outer wall 34 of the fluid guiding element 26. Furthermore, two inlet openings 30 are arranged diametrically opposite each other in the outer wall 34 of the fluid guiding element 26. Alternatively, it is conceivable that the inlet openings 30 have a shape other than a circular shape, for example an oval, rectangular or polygonal shape.

The fluid guiding element 26 has a locking element 48, which partially delimits an inner channel 32 of the fluid element 26, for locking with the closure element 46. The locking element 48 is designed as a spring locking element. The locking element 48, which is designed as a spring locking element, is designed as a rectangular section of the fluid guiding element 26 which is free-standing on three sides, has a main direction of extension parallel to the longitudinal axis 22 of the filter cleaning unit 20, and has a locking lug at its free-standing end. In the present embodiment, the fluid guiding element 26 has two such latching elements 48. The filter cleaning unit 20 has an impulse element 24. The impulse element 24 is trapezoidal in shape. Alternatively, another shape, for example a rectangular shape, of the impulse element 24 is conceivable. The impulse element 24 is arranged eccentrically offset relative to the longitudinal axis 22 of the filter cleaning unit 20 on the fluid guiding element 26. Furthermore, the impulse element 24 is arranged on an inner wall 36 of the fluid guiding element 26 which bounds the inner channel 32 of the fluid guiding element 26. The impulse element 24 extends through a fluid guiding element recess 38 of the fluid guiding element 26, which is bounded by an outer wall 34 of the fluid guiding element 26. The impulse element 24 extends across the outer surface 44 of the fluid guiding element 26 along a direction perpendicular to the longitudinal axis 22 of the filter cleaning unit 20. The impulse element 24 has a main extension axis which forms an angle deviating from 90° with the outer surface 44 of the fluid guiding element 26 extending parallel to the longitudinal axis 22 of the filter cleaning unit 20.

The filter cleaning unit 20 has at least one further impulse element 24 offset along the longitudinal axis 22 relative to the impulse element 24. The further impulse element 24 is arranged on the inner wall 36 of the fluid guiding element 26, which delimits the inner channel 32 of the fluid guiding element 26. The further impulse element 24 extends through a further fluid guiding element recess 38 of the fluid guiding element 26, which is bounded by the outer wall 34 of the fluid guiding element 26. The further impulse element 24 extends further across the outer surface 44 of the fluid guiding element 26 along a direction perpendicular to the longitudinal axis 22 of the filter cleaning unit 20. The fluid guiding element recess 38 and the further fluid guiding element recess 38 are arranged offset by 90° relative to one another in a circumferential direction of the fluid guiding element 26. However, it is also conceivable that the fluid guiding element recess 38 and the further fluid guiding element recess 38 are arranged offset from one another by a smaller angle. In the present embodiment, the filter cleaning unit 20 comprises two impulse elements 24, which are each arranged on the inner wall 36 of the fluid guiding element 26 and each have a main extension axis, wherein the main extension axes of the impulse elements 24 extend parallel to each other in an unstressed state. In particular, the illustrated embodiment has four such fluid guiding element recesses 38. In the embodiment shown, the impulse elements 24 are arranged on the inner wall 36 of the fluid guiding element 26, which delimits the inner channel 32 of the fluid guiding element 26. The impulse elements 24 each extend through one of the four fluid guiding element recesses 38 of the fluid guiding element 26. The impulse elements 24 extend over the outer surface 44 of the fluid guiding element 26. Two impulse elements 24 are arranged opposite each other on the inner wall 36 of the fluid guiding element 26. The present two pairs of oppositely arranged impulse elements 24 are arranged axially offset to one another along the fluid guide element 26. Furthermore, the present two pairs of oppositely arranged impulse elements 24 are arranged radially rotated by 90° relative to each other. FIG. 4 and the cross-section through the fluid guiding element 26 shown in FIG. 5 (cf. FIG. 4, along the dashed line and looking in direction B) show the arrangement of the impulse elements 24 and the respective fluid guiding element recesses 38 of the present embodiment.

The collection unit 14 of the particle collection device 10 comprises a further closure element 78. The further closure element 78 is designed as a closure cap. The further closure element 78 is arranged on the side of the collection unit 14 facing the power tool 12. The further closure element 78 has an inlet opening 80. The inlet opening 80 allows particle-laden fluid to flow from the suction nozzle 76 of the power tool 12 into the collection container 16. The further closure element 78 is connected to the collection container 16 of the collection unit 14 by a screw connection. Alternatively, however, it is conceivable that the further closure element 78 is connected to the collection container 16 of the collection unit 14 by means of a bayonet connection, a clamping connection or the like.

The particle collection device 10 is detachably connected to the suction nozzle 76 of the power tool 12 via the further closure element 78. Alternatively, however, it is also conceivable that the particle collection device 10 is non-detachably connected to the suction nozzle 76 of the power tool 12. The particles removed from the workpiece by the machining tool 42 are guided by an air flow generated by a fan impeller for motor cooling (not shown here) from the workpiece through the suction nozzle 76 through the inlet opening 80 into the particle collection device 10. However, it is also conceivable that the power tool 12 has a combination fan wheel, which has fan blades for motor cooling and further blades for dust extraction. Alternatively, it is also possible for the removed particles to be fed into the particle collection device 10 by a fan of the power tool 12, which is designed separately for cooling the motor and by means of which an air flow can be generated for dust extraction. Other embodiments of the power tool 12 that appear useful to a person skilled in the art for generating an air flow for dust extraction are also conceivable.

The filter unit 18 also comprises a further support element 70. In the present embodiment, the closure element 46 forms the further support element 70. Alternatively, however, it is also conceivable that the further support element 70 is a separate element from the closure element 46. The further support element 70 limits the outlet opening 28 for discharging the particle-filtered fluid from the filter element 56. The further support element 70 is connected to the filter element 56 by a material bond at an end of the filter element 56 facing away from the support element 58. The filter element 56 is arranged on the further support element 70 in such a way that the extensions 50 are arranged within the fluid flow channel 74 bounded by the filter element 56.

The outer side of the filter element 56 facing radially away from the longitudinal axis 22 is flowed against with particle-laden air and particle-filtered air can flow out through the fluid flow channel 74 bounded by the filter element 56 parallel to the longitudinal axis 22 of the filter unit 18. The particle-filtered fluid flows out of the filter unit 18 through the outlet opening 28 (FIG. 7).

What is claimed is:

1. A filter unit for a particle collection device which is detachably attached to a power tool, comprising:
at least one filter element configured to filter particles from a fluid flowing through the at least one filter element; and
at least one support element arranged at one end of the at least one filter element by a material bond,
wherein the at least one support element has a cross-sectional shape congruent with a cross-sectional shape of the at least one filter element, and
wherein the cross-section shape of the at least one filter element deviates from a circular cross-sectional shape and is star-shaped.

2. The filter unit according to claim 1, wherein:
the at least one support element has at least two radial extensions mutually spaced along a circumferential direction with respect to corresponding radial ends of the at least two radial extensions, and
the at least two radial extensions are arranged symmetrically about a center axis of the at least one support element in order to define the cross-sectional shape of the at least one filter element.

3. The filter unit according to claim 1, wherein:
the at least one support element has at least two radial extensions each having an abutment surface of a plurality of abutment surfaces configured to bear against the at least one filter element along a circumferential direction of the at least one filter element, and
the plurality of abutment surfaces delimits a receptacle for an arrangement of filter star prongs of the at least one filter element configured as a pleated filter.

4. The filter unit according to claim 2, wherein:
the at least one support element has at least one inner support wall configured to extent parallel to a center axis of the at least one filter element, and
the at least one inner support wall is configured to support the at least one filter element, which is arranged closer to the center axis with respect to a center axis of the at least one filter element than two of the at least two radial extensions of the at least one support element.

5. The filter unit according to claim 1, wherein:
the at least one support element has at least two radial extensions and at least one sword-like mounting centering extension, and
the at least one sword-like mounting centering extension is arranged on at least one of the at least two radial extensions on a side of the at least one support element facing away from the at least one filter element.

6. The filter unit according to claim 1, wherein:
the at least one support element has at least one serrated flow optimization geometry arranged on a side of the at least one support element facing away from the at least one filter element and arranged on at least two radial extensions of the at least one support element.

7. The filter unit according to claim 1, further comprising:
a further support element having at least one outlet opening configured to discharge a particle-filtered fluid from the at least one filter element,
wherein the further support element is arranged at an end of the at least one filter element facing away from the at least one support element, and
wherein the further support element is connected to the at least one filter element by the material bond.

8. A particle collecting device for a power tool, comprising:
at least one filter unit according to claim 1.

9. The particle collecting device according to claim 8, wherein:
the at least one support element has a hollow plain cylindrical guide and/or bearing element, on a side of the at least one support element facing the at least one filter element, and
the hollow plain cylindrical guide and/or bearing element is configured to guide and/or to bear a filter cleaning unit.

10. The particle collecting device according to claim 8, further comprising:
a collection unit including a collection container and a filter cleaning unit having a fluid guide element,
wherein the at least one filter unit has a further support element including at least one outlet opening configured to discharge a particle-filtered fluid from the at least one filter element,
wherein the at least one outlet opening is arranged at an end of the at least one filter element facing away from the at least one support element,
wherein the at least one outlet opening has a cross-sectional shape, deviating from a circular cross-section, and includes at least one extension configured to enable the fluid guide element to be inserted together with an impulse element of the filter cleaning unit extending over an outer surface of the fluid guide element into the collection container, and
wherein the at least one filter element is arranged such that the at least one extension is arranged within a fluid flow channel bounded by the at least one filter element.

11. A power tool, comprising:
at least one particle collection device according to claim 8.
